(19) United States
(12) Patent Application Publication
(10) Pub. No.: US 2016/0267519 A1
(43) Pub. Date: Sep. 15, 2016

(54) ALLOCATING ONLINE ADVERTISING BUDGET BASED ON RETURN ON INVESTMENT (ROI)

(71) Applicant: ADOBE SYSTEMS INCORPORATED, San Jose, CA (US)

(72) Inventors: DEEPAK PAI, SAN JOSE, CA (US); ZHENYU YAN, CUPERTINO, CA (US); FANGPO WANG, SAN JOSE, CA (US); JOSE MATHEW, SUNNYVALE, CA (US); ABHISHEK PANI, SAN FRANCISCO, CA (US)

(21) Appl. No.: 14/642,198

(22) Filed: Mar. 9, 2015

(51) Int. Cl. G06Q 30/02

(52) U.S. Cl. CPC G06Q 30/0242; G06Q 30/0275; G06Q 30/0277

(57) ABSTRACT

Embodiments of the present invention relate to allocating online advertising budget based on return on investment (ROI). Allocating an advertising budget based on ROI can facilitate advertisement bidding such that ROI can be optimized for the advertiser. In implementation, an online advertising budget is generally provided in connection with a budget time duration during which the online advertising budget is to be used. In determining a budget allocation in association with a particular feature, an indication of a ROI for each set of feature values is determined. The indication of the ROIs associated with each set of feature values can be used along with the advertising budget to identify an optimal allocation of the online advertising budget for the budget time duration. In some cases, constraints may also be applied to optimize budget allocation among the feature values.

### BACKGROUND

Advertising auctions are generally employed to select an advertisement to present to a user, for example, within an electronic document, such as a web page, served by a content server to a user device. Typically, the auction process includes comparing bid prices associated with competing advertisement campaigns and selecting the advertisement campaign having the highest bid price and/or the advertisement campaign determined likely to generate the highest advertising revenue for presentation of that advertisement. To facilitate the bidding process, some advertisers may utilize a demand side platform, such as the ADOBE MEDIA OPTIMIZER tool, to assist in determining a bid and, in some cases, placing a bid on behalf of the advertiser. In doing so, the advertiser typically allocates a defined budget to be spent on display advertising over a time duration, such as $1,000 per day. Because the advertising opportunities (requests for advertisement bids to display an ad to a visitor on a website) outnumber the available budget, bidding on every request results in exhausting the budget quite early in the day resulting in bid opportunities being missed during later hours of the day that could potentially lead to conversions.

As such, allocating or pacing the budget across the available duration is frequently used in an effort to optimize the advertisement opportunities such that the advertiser does not miss out on requests during the later hours that could potentially lead to conversions. One existing approach to resolve this lack of optimization is to uniformly distribute the budget over the available duration such that, for example, a daily budget of $2400 results in allocation of $100 to be spent every hour. As the requests are not uniformly distributed, however, this too may result in missed opportunities. For instance, certain hours of the day might have higher requests resulting in the budget being exhausted sooner as compared to other hours where the budget might remain unutilized. Another approach is to allocate the budget proportional to requests at given time slots. This approach, however, still limits the ability to optimize revenue and corresponding return on investment (ROI). For example, assume that a large portion of the budget is allocated to the morning hours based on the greater number of advertisements requests generated during the morning hours. In the event that revenue generated during the morning hours is low as compared to evening hours even though traffic is much higher during the morning, revenue may not be optimized. As another example, revenue in certain hours might come at a higher cost resulting in a lower ROI as compared to certain other hours.

### SUMMARY

Embodiments of the present invention relate to allocating online advertising budget based on return on investment (ROI). Allocating an advertising budget based on ROI can facilitate advertisement bidding such that ROI can be optimized for the advertiser. In this regard, a greater portion of a budget can be allocated to portions of time (e.g., hours) and/or other features leading to higher revenue and ROI to advertisers. In implementation, an online advertising budget is generally provided in connection with a budget time duration during which the online advertising budget is to be used. In determining a budget allocation in association with a particular feature, such as time, device type, geographical location, etc., an indication of a ROI for each set of feature values is determined. A feature value refers to a value or aspect of a feature and, in some cases, may be grouped together as a set of related feature values based on relatedness between the features (e.g., patterns of revenue and/or cost). The indication of the ROIs associated with each set of feature values can be used along with the advertising budget to identify an optimal allocation of the online advertising budget for the budget time duration. In some cases, constraints may also be applied to optimize budget allocation among the feature values. The optimized budget allocation can then be used, for example, to automatically determine whether to place bid in an online advertisement auction and/or to what extent. In this way, the advertiser can improve opportunities to increase return on investment in connection with advertisement displays.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a graphical depiction illustrating allocation by revenue in accordance with an embodiment of the present invention;

FIG. 3 is a flow diagram showing a method for allocating an online advertising budget based on return on investment in accordance with an embodiment of the present invention;

FIG. 4 is a flow diagram showing another first method for allocating an online advertising budget based on return on investment in accordance with an embodiment of the present invention; and

FIG. 5 is a block diagram of an exemplary system in which embodiments of the invention may be employed.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Online advertising can include presenting an advertisement within an electronic document, such as a web page, served by a content server to a user device. The web page may include an area for presenting an advertisement. When a user requests a web page from a content server, an advertising delivery engine may select an advertisement for presentation within the area provided by the web page. Advertising delivery engines often select advertisements for delivery and presentation within a web page using an auction process. In particular, an advertiser or a third-party associated with the advertiser, such as a demand side platform (e.g., Adobe Media Optimizer) establishes and places bids to participate in the real-time auction process. The determination to bid and/or an appropriate bid amount may be based on various data, such as publisher data (e.g., category of the webpage), visitor data (e.g., propensity of visitor to click or purchase, type of visitor device, geographic location of visitor), or other data (e.g., time of day). The auction generally compares bid prices associated with competing advertisement campaigns and selects the advertisement campaign having the highest bid price and/or the advertisement campaign determined likely to generate the highest advertising revenue for presentation of that advertisement. A successful bid results in an advertisement being presented to a visitor. Based on the auction mechanism, the bid winner pays a certain amount (cost) to the advertisement delivery engine. The visitor could then possibly click on the displayed advertisement which would navigate the visitor to the advertiser's website and, in some cases, result in the visitor making a purchase therefrom resulting in revenue to the advertiser.

To facilitate the bidding process, some advertisers may utilize a demand-side platform to assist in determining a bid and, in some cases, placing a bid on behalf of the advertiser. To assist in online bidding, some web analysis tools, such as the ADOBE MEDIA OPTIMIZER tool, have been developed to facilitate the bidding process. In using a third-party to facilitate bidding, the advertiser typically allocates a defined budget to be spent on display advertising. For example, an advertiser may provide $1,000 per day for utilization in online advertisement bidding, although any amount and/or time period may be specified. The specified budget can be used to determine and/or place bids for various advertisement bid requests (requests for advertisement bids to display an advertisement to a visitor on a website). Because the advertising opportunities (billions of requests per day across different publishers and advertisement delivery systems) outnumber the available budget, bidding on every request can result in exhausting a designated budget quite early in the day. As such, an advertiser may miss many requests during the later hours of the day that could potentially lead to conversions and, as a result, forego revenue opportunities.

In an effort to avoid early budget exhaustion, existing approaches to resolve this lack of optimization allocate or pace the budget by uniformly distributing the budget across an available duration. For example, assuming a daily budget of $2400 is provided, $100 can be allocated to be spent every hour to optimize the advertisement opportunities such that the advertiser does not miss out on requests during the later hours that could potentially lead to conversions. Because requests are not uniformly distributed throughout a time period, however, other existing approaches allocate the budget proportional to requests at given time slots in an effort to reduce missed conversion opportunities. For instance, certain hours of the day might have higher requests resulting in a budget being exhausted sooner as compared to other hours where budget might remain unutilized. This approach, however, still limits the ability to optimize revenue and corresponding return on investment (ROI). For example, assume that a large portion of a given budget is allocated to the morning hours based on a greater number of advertisement requests generated during the morning hours. In the event that revenue generated during the morning hours is low as compared to evening hours even though traffic is much higher during the morning, revenue may not be optimized. As another example, revenue generated in certain hours might come at a higher cost resulting in a lower ROI as compared to other hours of a day.

Embodiments of the present invention relate to allocating online advertising budgets in accordance with return on investment (ROI). Allocating an online advertising budget based on ROI facilitates real-time bidding such that ROI is optimized for the advertiser. In this regard, a greater portion of a budget can be allocated to portions of time (e.g., hours) and/or other features leading to higher revenue and ROI to advertisers. In implementation, an online advertising budget is generally provided in connection with a budget time duration during which the online advertising budget is to be used. In determining a budget allocation in association with a particular feature, such as time, device type, geographical location, etc., an indication of a ROI for each set of feature values is determined. A feature value refers to a value or aspect of a feature and, in some cases, may be grouped together as a set of related feature values based on relatedness between the features (e.g., patterns of revenue and/or cost). The indication of the ROIs associated with each set of feature values can be used along with the advertising budget to identify an optimal allocation of the online advertising budget for the budget time duration. In some cases, constraints may also be applied to optimize budget allocation among the feature values. The optimized budget allocation can then be used, for example, to automatically determine whether to place bid in an online advertisement auction and/or to what extent. In this way, the advertiser can improve opportunities to increase return on investment in connection with advertisement displays.

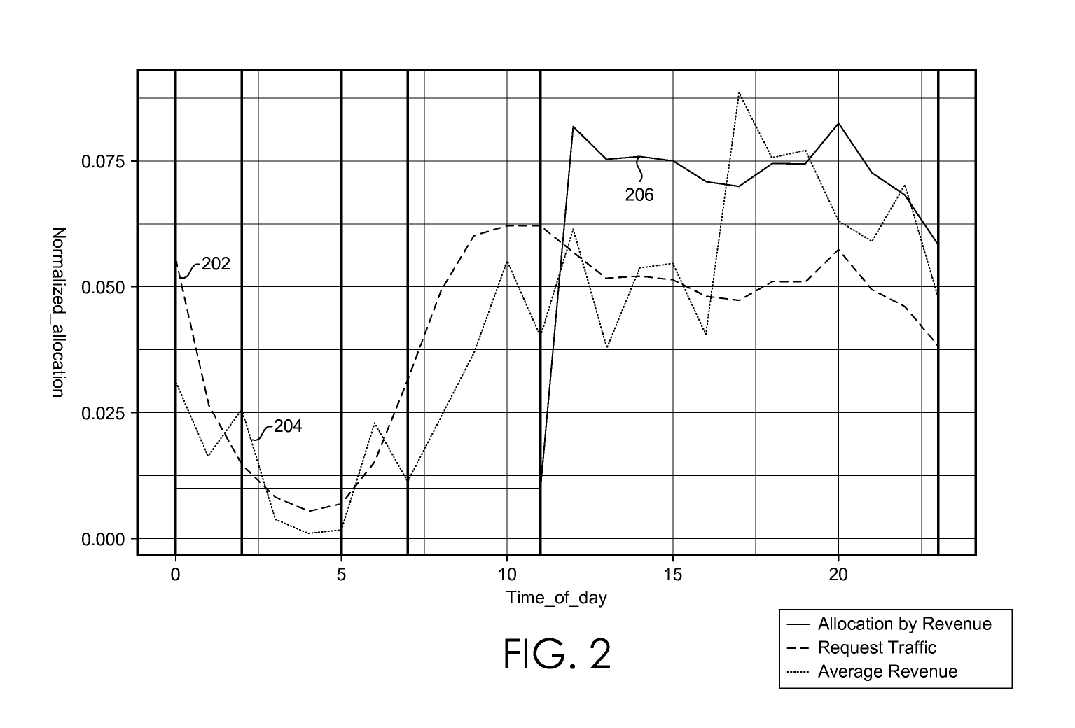

By way of example, and with brief reference to FIG. 2, assume that later hours of the day have higher revenue, as illustrated by average revenue 204, while initial hours of the day have reasonably high requests, as illustrated by request traffic 202. Existing methods allocate a higher budget to the initial hours based on the elevated number of requests. Such an approach, however, would result in lower budget allocation to the later hours and, therefore, missed revenue opportunities. In accordance with embodiments described herein, periods of high revenue can be identified and an advertising budget allocated accordingly, as illustrated by allocation by revenue 206.

Allocating an online advertising budget based on a time feature or in a temporal manner is only one method of implementation of the technology described herein. In addition to or in the alternative to allocating a budget based on time, the allocation of budget can apply to different enumerations of available features. Examples of features include device type, geographic location, demographic attributes, webpage attributes, etc. Accordingly, an online advertising budget can be allocated based on ROI in accordance with any feature of combination of features.

Various terms are used throughout this description. Although more details regarding various terms are provided throughout this description, general definitions of some terms are included below to provide a clearer understanding of the ideas disclosed herein:

Return on investment, or ROI, refers to a performance measure used to evaluate efficiency of an investment or to compare investments. Generally, to calculate ROI, the benefit (return) of an investment is divided by the cost of the investment, the result of which is sometimes expressed as a percentage or ratio. Although ROI is generally described herein in terms of a monetary value (e.g., revenue per cost), return on investment can refer to a metric of interest, for instance, to a business. For instance, a number of trial downloads of a software might be a metric of interest to a business although not directly associated with a monetary value.

Advertisement bid or bid refers to a bid or monetary value an advertiser is willing to pay for presentation, selection, or conversion (or action) of a particular advertisement or one of a set of advertisements. For example, a bid of ten cents may indicate a willingness to pay ten cents to display an advertisement related to a particular restaurant. As another example, a bid of ten cents may indicate a willingness to pay ten cents upon presentation of an advertisement resulting in a selection of the advertisement (e.g., click through) or a conversion (e.g., user purchases an item for sale, completes and submits a form, etc.). A real-time bid refers to an advertisement bid that is provided in real-time just prior to or concurrent with an advertisement auction. In this regard, a real-time bid is an advertisement bid that is placed or indicated prior to or concurrent with conducting an advertisement auction.

A budget or advertising budget refers to a monetary amount defined or designated to be spent on display advertising. For example, an advertiser may provide $1,000 per day for utilization in online advertisement bidding, although any amount and/or time period may be specified. A specified budget can be used to determine and/or place bids for various advertisement bid requests.

A budget time duration refers to an amount of time associated with a budget. That is, a budget time duration specifies an amount of time during which a budget is to be utilized.

A feature refers to any feature being analyzed to determine how to allocate a budget. By way of example, a feature may be, for instance, time, demographic information, device type, advertisement type, etc. Each of the features may have various feature values, that is, a value or value range that corresponds with a variation of a feature. For a time feature, feature values of time may be any granularity of period of time, such as an hour time duration. For instance, assume that a time period over which a budget is to be allocated is one day. In such a case, assuming the feature values are one hour time durations, 24 feature values exist (e.g., 12:00 am-1:00 am, 1:00 am-2:00 am, 2:00 am-3:00 am, etc.). As another example, a device type feature may have feature values of desktop, laptop, phone, and tablet.

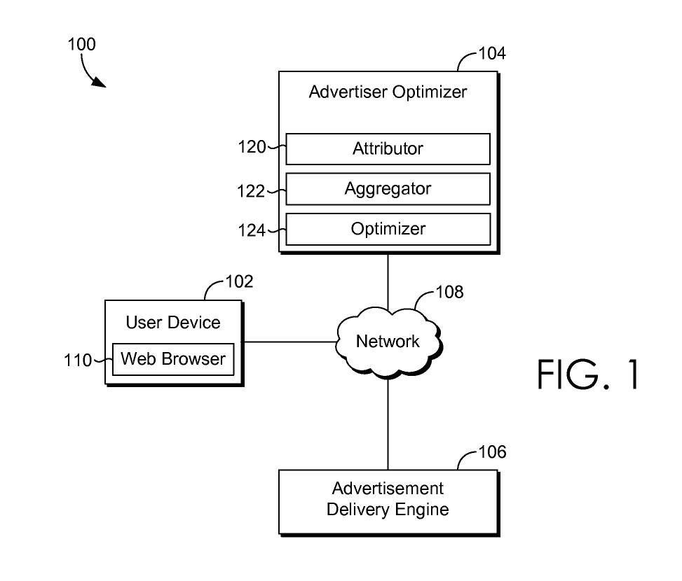

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as environment 100.

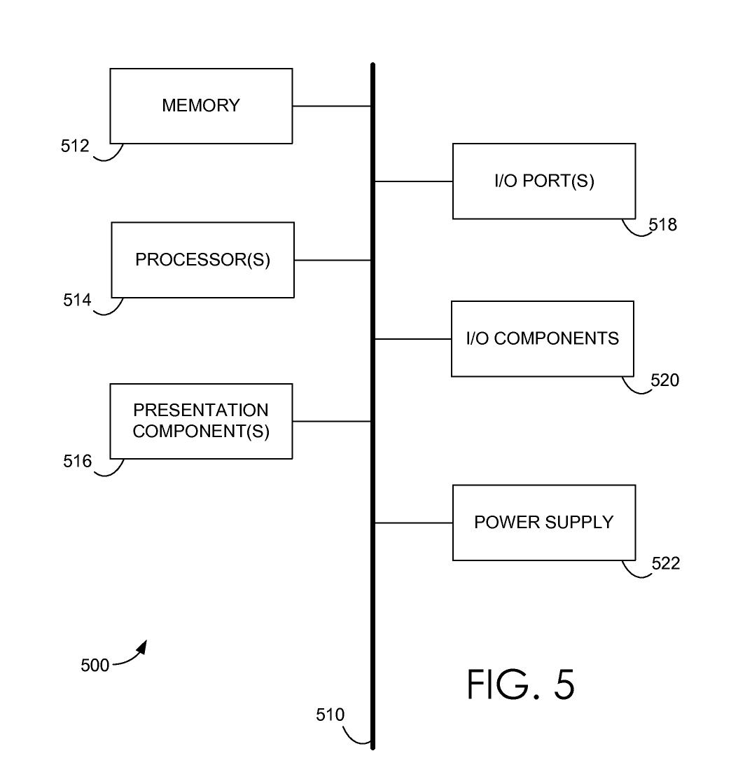

The environment 100 of FIG. 1 includes a user device 102, an advertiser optimizer 104, and an advertisement delivery system 106. Each of the user device 102, advertiser optimizer 104, and advertisement delivery system 106 may be, or include, any type of computing device (or portion thereof) such as computing device 500 described with reference to FIG. 5, for example. The components may communicate with each other via a network 108, which may include, without limitation, one or more local area networks (LANs) and/or wide area networks (WANs). Such networking environments are commonplace in offices, enterprise-wide computer networks, intranets, and the Internet. It should be understood that any number of user devices, advertiser optimizer, and advertisement delivery systems may be employed within the environment 100 within the scope of the present invention. Each may comprise a single device or multiple devices cooperating in a distributed environment. For instance, the advertiser optimizer 104 and/or advertisement delivery system 106 may be provided via multiple devices arranged in a distributed environment that collectively provide the functionality described herein. Additionally, other components not shown may also be included within the environment 100, while components shown in FIG. 1 may be omitted in some embodiments.

The user device 102 may be any type of computing device owned and/or operated by a user or website visitor that can access network 108. For instance, the user device 102 may be a desktop computer, a laptop computer, a tablet computer, a mobile device, or any other device having network access. Generally, a user may employ the user device 102 to, among other things, access electronic documents maintained by content servers (not shown). For example, the user may employ a web browser 110 on the user device 102 to access and view electronic documents from one or more content servers. Such content servers may be any type of server device capable of hosting electronic documents from a publisher and serving the electronic documents to computing devices, such as the user device 102. By way of example, and not limitation, a content server may be a server maintaining web pages for a publisher website.

Space may be provided on an electronic document or web page for presenting advertisements. In particular, when a user accesses a web page from a content server, the advertisement delivery system 106 may facilitate selection and delivery of an advertisement(s) for presentation within the web page. In some embodiments, a web page accessed by a user may be a web page for a search engine to allow a user to search for relevant data. In such a case, a user may enter, input, or otherwise provide a search query (i.e., one or more search terms) for which related information is desired. A search query can be input via a search box associated with the search web page. Exemplary Internet search engines are well known in the art. In other embodiments, a web page accessed by a user may be any web page. In any case, when a user requests a web page or navigates thereto, such as a search results web page from a content server(s), the advertisement delivery system 106 can select an advertisement for presentation within an area(s) provided by an electronic document, or a portion thereof.

Upon the web browser 110 of the user device 102 obtaining the web page and/or selected advertisement(s), the web browser 110 can cause display such that the user of the user device 102 can view the webpage and corresponding advertisement(s). The web browser 110 is configured to render a web page(s), such as a search results web page. By way of example only, assume that a user submits a search query via a search web page. In response, the search results web page having a corresponding advertisement(s) deemed relevant to the webpage or search query can be presented to the user on a display via the web browser 110.

The advertiser optimizer 104 is generally configured to facilitate real-time bidding for advertisement presentation in an effort to optimize revenue and/or ROI. Typically, the advertiser optimizer 104 communicates with the advertisement delivery system 106 to provide bids in participation of an auction (e.g., real-time auction). In accordance with embodiments described herein, the advertiser optimizer 104 can include an attributor 120, an aggregator 122, and an optimizer 124. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In some embodiments, one or more of the illustrated components/modules may be implemented as stand-alone applications. In other embodiments, one or more of the illustrated components/modules may be integrated directly into the operating system of the advertiser optimizer 104. The components/modules illustrated in FIG. 1 are exemplary in nature and in number and should not be construed as limiting. Any number of components/modules may be employed to achieve the desired functionality within the scope of embodiments hereof. Further, components/modules may be located on any number of servers, computing devices, or the like. By way of example only, the advertiser optimizer 104 might reside on a server, cluster of servers, or a computing device remote from or integrated with one or more of the remaining components.

The advertiser optimizer 104 may be any type of computing device, or incorporated into a computing device, owned and/or operated by an advertiser, or a representative thereof, that can access a network (e.g., network 108). For instance, the advertiser optimizer 104 may be a desktop computer, a laptop computer, a tablet computer, a mobile device, a server, or any other device, or portion thereof, having network access. Generally, an advertiser or third-party in association therewith may employ the advertiser optimizer 104 to, among other things, manage advertisement bidding associated with the advertiser. An advertiser may be an individual or a representative of a company, an association, an organization, an institution, etc. that facilitates submission of an advertisement, or data associated therewith, for use in electronic display.

The advertiser optimizer 104 is generally described herein as demand-side platform, or third-party platform that operates on behalf of an advertiser to facilitate real-time advertisement auctions for the advertiser. In this regard, the advertiser optimizer 104 can generally determine how much to bid for a given advertisement or set of advertisements in accordance with a budget received from the advertiser. In this way, the advertiser optimizer 104 may communicate with an advertiser device (not shown) in an effort to facilitate real-time bids. Such communication therebetween may include advertiser preferences, budgets, analysis, or the like, as described in more detail below.

Although the advertiser optimizer 104 is generally described as being associated with a third-party operating on behalf of an advertiser, the functionality described herein can similarly be used directly by an advertiser (e.g., via an advertiser device) to facilitate real-time bidding by the advertiser. In this regard, the functionality described in connection with the advertiser optimizer 104 can be employed via an entity providing an advertisement in an effort to optimize revenue and/or return on investment. Further, such technology might additionally or alternatively be implemented by an advertisement delivery system, such as advertisement delivery system 106, for utilization by an advertiser, or representative thereof, to employ the functionality described herein. For example, an advertisement delivery system might offer such functionality for access and use by an advertiser.

As previously mentioned, in embodiments, the advertiser optimizer 104 includes an attributor 120, an aggregator 122, and an optimizer 124 to facilitate advertisement bidding and optimization of revenue and/or ROI in association therewith. In particular, the advertiser optimizer 104 functions to allocate a designated budget for a designated time duration (budget time duration) in a way that optimizes revenue and/or ROI. Revenue generally refers to income or proceeds. Return on investment, or ROI, refers to a performance measure used to evaluate efficiency of an investment or to compare investments. Generally, to calculate ROI, the benefit (return) of an investment is divided by the cost of the investment, the result of which is sometimes expressed as a percentage or ratio. Although ROI is generally described herein in terms of a monetary value (e.g., revenue per cost), return on investment can refer to a metric of interest, for instance, to a business. For instance, a number of trial downloads of a software might be a metric of interest to a business although not directly associated with a monetary value. Although implementations described herein generally discuss ROI optimization, embodiments of the present invention might apply to optimizing other financial gains, such as revenue, profit, or the like.

The attributor 120 is generally configured to attribute or designate revenue and/or cost to an event(s). Attribution is the process of identifying an event or set of events (or touch points) that contribute to a desired outcome and, thereafter, assigning a value to one or more of the events. An event or touch point refers to any event or point along the path of achieving a conversion or other revenue means. An event may be, for example, an ad displayed on a webpage, a click on an advertisement, a social network post, etc. Generally, there are multiple touch points or events, such as ad presentations and user selections/navigations, occurring before a conversion is actually performed. Because of the multiple events leading up to a conversion, it is oftentimes desirable to attribute condition on revenue that is appropriate to each of these events or touch points, as appropriate, to designate an event or set of events as contributing to the conversion. As such, performing attribution provides an indication of an event(s) that influences individuals to engage in a particular behavior, resulting in a revenue gain or conversion. Accordingly, attribution is used to quantify the influence an event(s) has on a consumer's decision to make a purchase decision, or convert. By attributing revenue to an event(s), historical revenue data and patterns can be identified and used to allocate advertising budget.

An attribution model can be used to perform or achieve this attribution, that is, attribute revenue to an event(s). An attribution model refers to a rule, or set of rules, that determine how revenue is assigned to touch points or events in a revenue path (i.e., a path to a conversion or revenue). Any type of attribution model can be implemented within the scope of embodiments described herein.

Examples of attribution models include single source attribution, fractional attribution, and algorithm or probabilistic attribution. A single source attribution generally refers to a model that assigns all credit to a single event, such as a last event (e.g., last click, last touch point, last ad presentation, etc.) or a first event (e.g., first click, first touch point, first ad presentation, etc.). A fractional attribution generally refers to a model that assigns equal or curved (e.g., U-curved) weights or credits to multiple events, such as equal attribution to each event or touch point in a revenue path. Algorithmic or probabilistic attribution uses automated computation to determine and assign revenue across touch points and events preceding the conversion. Specific examples of attribution models include a last interaction attribution model, a last non-direct click attribution model, a first interaction attribution model, a linear attribution model, a time decay attribution model, and a position based attribution model. A particular attribution model for use by the attributor 120 can, in some cases, be selected by an advertiser, or representative thereof. In this way, an advertiser, or representative thereof, can select an attribution model from a set of potential attribution models based on the advertiser's preferences. The available set of potential attribution models can be of any number and is not intended to limit the scope of embodiments of the present invention. Rather, the attribution models described herein are meant to be exemplary in nature.

By way of example only, assume that several events precede a conversion including a first event of an advertisement being displayed on first page, a second event of a user clicking on one or more of advertisements, and a third event of a related posting on a social networking website. Based on a selected attribution model, one or more of the events can be selected for attributing the revenue associated with the conversion. To this end, the conversion revenue can be attributed to the advertisement display, the advertisement selection, and/or the social network posting depending on the model employed. Upon attributing revenue to one or more events, such data can be used to determine an allocation on an allotted budget, as described in more detail herein.

The aggregator 122 is configured to gather and aggregate data related to revenue and/or costs. Aggregating data, such as revenues and costs, can facilitate identification of budget allocation in accordance with ROI. In particular, because conversions are not generally frequent occurrences relative to the extent of online advertising thereby resulting in sparse data, aggregating data to utilize in determining budget allocation can enhance the results. Data, such as costs and revenues, can be gathered in association with various feature values. A feature refers to any feature being analyzed to determine how to allocate a budget. By way of example, a feature may be, for instance, time, demographic information, device type, advertisement type, etc. Each of the features may have various feature values, that is, a value or value range that corresponds with a variation of a feature. For a time feature, feature values of time may be any granularity of period of time, such as an hour time duration. For instance, assume that a time period over which a budget is to be allocated is one day. In such a case, assuming the feature values are one hour time durations, 24 feature values exist (e.g., 12:00 am-1:00 am, 1:00 am-2:00 am, 2:00 am-3:00 am, etc.). As another example, a device type feature may have feature values of desktop, laptop, phone, and tablet.

Irrespective of the feature, data can be aggregated in connection with corresponding feature values. In this way, data is aggregated with other data associated with the same feature value. A particular event(s) to which revenue is attributed, as designated by the attributor 120 for example, can be associated with a particular feature value and, thereafter, aggregated with other data having the same feature value. For example, assume that a particular revenue is attributed to a first event, which occurred at 10:30 am. Such a revenue can be associated with a particular feature value of between 10:00 am and 11:00 am and aggregated with other revenue also attributed to events occurring between 10:00 am-11:00 am. As another example, assume that a particular revenue is attributed to a first event, which occurred by way of a mobile device. Such a revenue can be associated with a mobile device feature value and aggregated with other revenue also attributed to events occurring via a mobile device.

Data can be aggregated over any aggregation time period. For instance, 30 days of historic data might be used to aggregate data. The duration for which data is aggregated is not intended to limit the scope of embodiments herein. The aggregated data can be stored in a data store, such as a database accessible by the advertiser optimizer 104.

In some cases, in addition to aggregating data in connection with a particular feature value over an aggregation time period, the aggregator 122 can aggregate data, such as revenue and costs, corresponding with feature values associated with similar behaviors. In this way, data associated with multiple feature values may be aggregated together. That is, data associated with related feature values can be aggregated over an aggregation time period (e.g., 30 days). Generally, related feature values are a set of one or more feature values wherein the cost and/or revenue follow a similar pattern. For example, revenue associated with desktops and laptops may have similar behavior while revenue associated with phones and tablets may be alike. In such a case, revenue and/or cost data for desktop and laptops (e.g., first and second feature values) can be aggregated while revenue and/or cost data associated with phones and tablets (e.g., third and fourth feature values) can be aggregated. Combining data associated with multiple feature values (related feature values) can assist with solving data sparsity issues. On the other hand, if different feature values are associated with different behaviors, then it is ideal to build individual models for each of them.

Determining related feature values, or features values for which data should be aggregated, can be performed in any number of ways. As described herein, in some embodiments, the aggregator 122 can algorithmically determine if feature values should be combined or used independently. One exemplary method for making such a determination is described herein; however, the method employed is not intended to be limited herein. Generally, in such an exemplary method, various groups or chunks of feature values, or data associated therewith, are analyzed to identify sets of feature values that appear to have similar characteristics. A number of iterative analyses may be performed to identify related feature values.

In embodiments, to determine related feature values, a set of feature values for a feature, and data associated therewith, can be split into two groups or chunks. To identify an initial best split for the feature values, the data can be split into various combinations of two groups of feature values. For instance, potential combinations of feature values, and data associated therewith, can be considered to find the best split in a first iteration. By way of example only, assume a feature of time is being analyzed for allocating a prescribed budget. Further assume that the feature values are 0-1, 1-2, 2-3, 3-4, . . . 23-24, representing 24 hours within a day. In such a case, the feature values can be grouped into possible combinations while maintaining consecutive values together. In this regard, a group or chunk might refer to a contiguous sequence of time frames. For instance, a first split might have the two combinations of 0-1 and 1-24, a second split might have the two combinations of 0-2 and 2-24, a third split might have the two combinations of 0-3 and 3-24, and so on, resulting in 23 splits of data for the 24 feature values. The best split from among the 23 splits of data can be identified by analyzing the variance between the groups of data. For instance, a split is considered significant if the two groups formed have significant variance. In analyzing the data splits, a linear model, such as a regression model, can be fitted to or applied to the data associated with the feature values in a group. As such, a first linear model can be determined from data associated with feature values in a first group, and a second linear model can be determined from data associated with feature values in a second group. The linear models, or portion thereof, can then be compared to one another to determine if significant variance exists between the two groups of data. For example, model coefficients can be evaluated using ANOVA (regression based ANOVA) to check for significant values. The p-value from the analysis is an indicator of the significance. P-value generally refers to the probability of obtaining the observed sample results (or a more extreme result) when the null hypothesis is actually true. In some cases, if the p-value is less than 0.05, which corresponds to 95% confidence, a conclusion can be made that the two groups have differing characteristics. In the example of the time feature, 23 group splits can be initially analyzed. The above analysis can be performed for every split to find the best split (one with the least p-value).

For each group or set of feature values in the split, the process is recursively repeated. For instance, assume a top-level analysis determines the best split of the feature values corresponds with a first group of 0-3 and a second group of 3-24. In such a case, the analysis described above can be applied to the first group 0-3 to identify a best split thereof, and analysis can be applied to the second group 3-24 to identify a best split of the second group. Such analysis can be recursively applied for each split group. When significant variance does not result between two groups considered to have the greatest significance in a split (e.g., via ANOVA), the recursive analysis can be stopped and the two groups merged back together as a chunk.

The outcome of this recursive analysis provides an indication of data splits having significant variance. In this regard, the feature values associated with the data splits can be identified as related feature values and the corresponding data can be aggregated together. Although the examples provided above refer to time as the feature, this process can be applied to any type of feature. As can be appreciated, in cases that the feature is not contiguous, such as a contiguous sequence of time frames, the chunks do not need to be grouped in such a manner.

The optimizer 124 is configured to utilize the aggregated data and determine an optimal budget allocated based on ROI. Aggregated revenue and/or cost data can be used in various implementations to optimize budget allocation using the revenue and/or cost data. In some embodiments, each set of related feature values, and data associated therewith, is used to facilitate budget allocation optimization. To this end, such data can be used to determine an indication of a return on investment for each set of one or more feature values corresponding with a feature being utilized to determine an allocation of the online advertising budget. In some embodiments, for each set of related feature values (e.g., as determined by the aggregator 122), a model is generated, such as a linear model, to provide an indication of a ROI. For example, a log relationship, such as log-revenue as a function of log-cost, can be used. A logarithmic transformation enables a linear model to fit on the data. Log-revenue might be a dependent variable, while log-cost and aggregated related feature values are independent variables. In some cases, interaction terms can be included or added to better model the interactions of independent variables among themselves. A linear model can be fit on the variables to obtain a slope(s) and intercept(s) for each set of related feature values. As can be appreciated, the data might be divided in some cases such that a portion is used for training while the other portion is used to test the model. For instance, 80% of the data might be used for training while the remaining 20% of the data is used for testing. In some implementations, a 10-fold cross validation can be used to avoid over-fitting.

As such, a model is generated for each set of related feature values. For instance, assume two sets of related feature values are identified, one set representing hours 0-12 and the other set representing hours 12-24. For each set, a model is generated that includes or returns, for each set, a slope (coefficient) and intercept of a line that best fits the data in that set. If three sets of related feature values exist, then three separate models to fit the data in the corresponding data set are generated, and so on. A linear model is generally described herein, but the scope of embodiments of the present invention is not intended to be limited thereto. Further, although generally described herein as generating a model for each set of related feature values, as can be appreciated, in some embodiments, a model may be generated for each feature value.

The optimizer 124 can use the advertising budget and the indication of the return on investment for each set of the one or more feature values to identify an optimal allocation of the advertisement budget (e.g., for the budget time duration). In embodiments, the optimizer 124 can utilize the generated models, or portions thereof, along with the designated budget to optimize the budget allocations. Any algorithm can be used to optimize budget allocations. In some cases, the slopes (coefficients) of the generated models can be compared to one another to determine the set of related feature values that would likely result in a greater ROI. For example, assume a first set of related feature values has a higher slope (coefficient) than the slope associated with a second set of related feature values, that is, the first set of related feature values has a higher ROI as compared to the second set of related features. In such a case, the optimizer 124 might provide a recommendation to allocate the budget in association with the first set of related feature values.

In some cases, the optimizer 124 uses constraints to facilitate budget allocation. In such cases, the optimizer 124 generally maximizes ROI subject to one or more constraints associated with the sets of feature values. Examples of constraints include upper and lower bounds on the budget for each set of feature values, or portions thereof. An upper and/or lower bound can be designated or determined in any manner. For instance, such bounds might be determined algorithmically, advertiser selected, or be otherwise configurable. A gradient descent mechanism can be used to arrive at an optimal solution that estimates budget to allocate to one or more sets of feature values.

By way of example, assume that a budget allocation of $1000 is provided on a daily basis and that two sets of related feature values have been identified. Further assume that slope (coefficient) for the first set of related feature values is determined to be greater than the slope (coefficient) for the second set of related feature values. Now assume that a lower constraint is 1% for both sets and that an upper constraint is 60% for the first set and 50% for the second set. In such a case, based on the lower constraints, at least $10 will be allocated to the first set of related feature values and at least $10 will be allocated to the second set of related feature values. Because the first set of related features is associated with a greater ROI, the budget allocation can be maximized to the upper constraint for the first set, which is $600 (or 60%) in this example. As such, the second set of related features can be allocated the remaining $400 of the $1000 daily advertising budget.

As can be appreciated, the lower and upper constraints can be any values. For instance, in some cases, the lower constraint of 1% (e.g., per hour) can be a configurable parameter set as a minimum budget amount such that advertisements can be presented in association with sets of related feature values in addition to the set associated with the highest ROI. For instance, if a set of related feature values includes hours 0-5, the lower constraint for that set might be 5%. A lower constraint might be set or established for any number of reasons. For instance, foregoing advertisement presentation in association with some sets of related feature values may prevent data gathering or analysis in association with such feature values and result in missing out on potential future revenue.

An upper constraint might be designated for different reasons. For instance, an upper constraint may be based on historical data so that an unnecessarily high allocation or disproportionate amount does not result. For instance, assume that $100 has been historically spent for a particular feature value and has been able to service one million advertisement requests. If $200 is delegated for that same feature value, the number of relevant auctions in which to participate or win may not increase and, as such, there is not enough demand to justify the increase in budget allocation. As such, an upper constraint may be based on historical data such that the upper constraint is not substantially greater than prior amounts spent (e.g., not more than 1.25 times the maximum amount spent in association with a feature value or set of feature values during a certain time period).

In some implementations, the budgets allocated to each set of related feature values might be allocated with further granularity, such as in accordance with the feature values within the set of related features. For instance, assume that a budget of $100 is allocated to a time frame of hours 0-4. As such, the optimizer 124 may further designate portions of the $100 allocation to each of the hours within the four hour time frame. Such a secondary budget allocation might be based on any number of factors. One example for further allocating a budget is based on traffic patterns. For instance, continuing with the example of $100 allocated to hours 0-4, assume that the traffic patterns for the corresponding hours are 1, 1.5, 2, and 0.5 million, respectively. With this approach, hour 0-1 would be allocated a budget of $25, hour 1-2 would be allocated a budget of $37.5, hour 2-3 would be allocated a budget of $50, and hour 3-4 would be allocated a budget of $12.5. Other methods of allocation might be implemented, such as, for example, each feature value within the feature value set might be allocated equal portions of the designated budget.

In some implementations, budget allocations for various features are combined. Various approaches might be used to designate allocations across multiple features. In one approach, budget allocations for a first feature can be designated, for example, as described above. Based on the allocation for the first feature, that designated allocation can be applied to a second feature for allocation to various feature values associated with the second feature. For instance, assume two features being analyzed are time and device type. Further assume that budget allocations have been determined for various sets of related feature values related to time. In such a case, for each set of related feature values, the allocation process is repeated with regard to device type. To this end, assume that a budget of $100 is allocated to hours 0-2. In such a case, using the $100 allocation as a budget, allocation is determined with respect to each device type or set of related device types. Such an approach allows allocation computation at granular levels considering appropriate trends.

In another approach, allocations are independently computed for each feature. The allocations can then be represented as percentages or ratios rather than absolute values. Taking features one at a time, the pre-computed percentages can be applied to the group and allocations computed in the previous step. For example, a budget of $100 can be applied to each feature, such as time and device type. Assume that based on the time feature, 75% of budget is allocated to a first time set of hours 0-17, and based on device type, 40% of budget is allocated to a first device type of mobile device. The allocated proportions can be combined (e.g., multiply the fractions) to compute a budget allocation for that time feature and device type.

Upon determining budget allocations for various feature values, the optimizer 124 may provide or utilize such budget allocations to facilitate bid placement, for instance, in a real-time bidding process. For example, in some embodiments, the optimizer 124 might provide the budget allocation to another service, such as a bidding service operated by another party (e.g., an advertiser or third-party bidding on behalf of an advertiser). In other embodiments, the budget allocation can be used by the advertiser optimizer 104 to facilitate bid placement, for example, on behalf of an advertiser. The budget allocation may be used to determine whether and/or to what extent to provide a real-time bid.

The advertisement delivery system 106 can receive a bid, such as a real-time bid, and utilize the bid in an advertisement auction to select an advertisement to deliver to a user. For example, assume that a bid of two cents is provided to the advertisement delivery system 106 in response to an advertisement request. Now assume that the advertisement associated with the two cent bid is successful in the auction. The advertisement delivery system 106 can provide an associated advertisement for transmission to a user. In some implementations, the advertisement delivery system 106 might communicate the advertisement to the user device (after the ad is selected in the advertisement auction). In other implementations, the advertisement delivery system 106 might provide the advertisement to another component (at auction time or after advertisement selection) for provision to the user device.

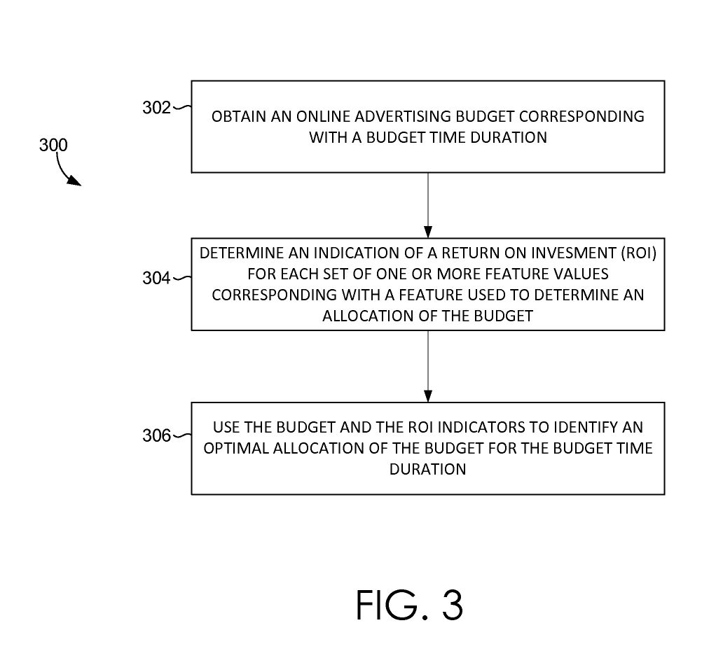

Turning to FIG. 3, a flow diagram is provided that illustrates a method 300 for allocating an online advertising budget based on ROI in accordance with an embodiment of the present invention. Such a method can be performed, for example, at an advertiser optimizer, such as advertiser optimizer 104 of FIG. 1. As shown at block 302, an online advertising budget corresponding with a budget time duration during which the online advertising budget is to be used is obtained. In some cases, an online advertising budget is designated by an advertiser. The amount of the budget and the time frame for utilization of the budget can be any amount. At block 304, an indication of a return on investment for each set of one or more feature values corresponding with a feature being utilized to determine an allocation of the online advertising budget is determined. In some cases, the feature and/or feature values can be designated or selected, for example, by an advertiser. As described herein, various feature values may be included in a set when the feature values are determined to be related to one another, for example, in terms of cost and/or revenue patterns. An ROI for each corresponding feature value set can be determined in any number of ways. As one example, the ROI might be determined by computing a linear model that best fits data associated with feature values included in the set. Upon determining indications of ROIs, as indicated at block 306, the online advertising budget and the indication of the ROI for each set of the one or more feature values are used to identify an optimal allocation of the online advertising budget for the budget time duration. In this way, the online advertising budget can be apportioned to various feature values (e.g., time increments, device types, etc.) in accordance with the more favorable ROIs. In some cases, one or more constraints pertaining to the sets of feature values may also be employed to optimize allocation. In this regard, a lower constraint and/or upper constraint can be used to increase or limit the amount of budget allocated in association with various feature values. Such constraints can be provided in any manner, such as, based on a preference indicated by an advertiser.

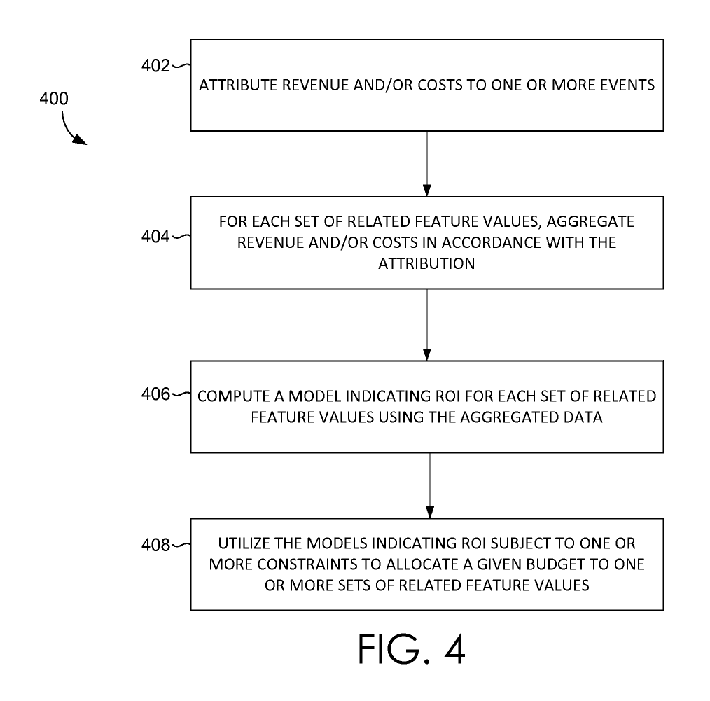

Turning now to FIG. 4, a flow diagram is provided that illustrates another method 400 for allocating an online advertising budget based on ROI in accordance with an embodiment of the present invention. Such a method can be performed, for example, at an advertiser optimizer, such as advertiser optimizer 104 of FIG. 1. Although the method 300 of FIG. 3 and the method 400 of FIG. 4 are provided as two separate methods, the methods, or aspects thereof, can be combined into a single method. As can be appreciated, additional or alternative steps may also be included in different embodiments.

Initially, as indicated at block 402, revenue and/or costs are attributed to one or more events. As such, revenue and/or costs are associated with one or more touch points or events that ultimately lead to a conversion. Such an attribution enables the revenues or costs to be aggregated appropriately. At block 404, for each set of related feature values, revenue and/or costs are aggregated in accordance with the attribution. For example, assume that feature values are time increments and that two hours are identified as being related to one another in terms of revenue and/or cost patterns. In such a case, revenues and/or costs attributed to fall within the combined two hour increment can be aggregated for use in optimizing budget allocation.

At block 406, a model indicating ROI is computed for each set of related feature values using the aggregated data. In embodiments, the model might be a linear model that best fits the data associated with the corresponding set of related feature values. The computed models, or portions thereof, indicating ROI can be used along with one or more constraints (e.g., upper bounds or lower bounds) to allocate a given budget to one or more sets of related feature values. This is indicated at block 408. The constraints may be imposed to establish lower or upper boundaries for allocating the budget. In some cases, the budget may be further allocated, for instance, to connection with each feature value within the set of feature values. For instance, assume that a budget portion of $200 is allocated to a set of feature values comprising two one-hour time segments. In such a case, the $200 may be further divided between each of the one-hour time segments such that $75 is allocated to the first hour while $125 is allocated to the second hour. The allocations can then be used to facilitate placement of real-time advertisement bidding.

Having described an overview of embodiments of the present invention, an exemplary computing environment in which some embodiments of the present invention may be implemented is described below in order to provide a general context for various aspects of the present invention.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

Accordingly, referring generally to FIG. 5, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

With reference to FIG. 5, computing device 500 includes a bus 510 that directly or indirectly couples the following devices: memory 512, one or more processors 514, one or more presentation components 516, input/output (I/O) ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterates that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as, stereoscopic camera systems, infrared camera systems, RGB camera systems, and combinations of these for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, embodiments of the present invention provide for, among other things, facilitating budget allocation based on return on investment. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by a computing device, cause the computing device to perform a method for allocating advertising budgets based on return on investment (ROI), the method comprising:
referencing an online advertising budget corresponding with a budget time duration during which the online advertising budget is to be used;
determining an indication of a return on investment for each set of one or more feature values corresponding with a feature being utilized to determine an allocation of the online advertising budget; and
using the online advertising budget and the indication of the return on investment for each set of the one or more feature values to identify, via a processor, an optimal allocation of the online advertising budget for the budget time duration, wherein the allocated online advertising budget is used to place one or more bids in a real-time online advertising auction.

2. The one or more computer storage media of claim 1, wherein the feature being utilized to determine the allocation of the online advertising budget comprises time, a device type, a geographical location, a demographic attribute, or a webpage attribute.

3. The one or more computer storage media of claim 1, wherein each set of the one or more feature values comprises a group of related feature values, wherein feature values are related based on similar patterns of revenues or costs associated therewith.

4. The one or more computer storage media of claim 3, wherein a determination of related feature values is made using a linear regression analysis.

5. The one or more computer storage media of claim 1, wherein the indication of the return on investment for each set of the one or more feature values is determined using a linear model in association with log-revenue and log-cost variables.

6. The one or more computer storage media of claim 1, wherein one or more constraints are used to identify the optimal allocation of the advertisement budget.

7. The one or more computer storage media of claim 1, wherein the optimal allocation allocates at least a portion of the online advertising budget to the set of one or more feature values associated with the greatest return on investment.

8. A method for allocating advertising budgets based on return on investment (ROI), the method comprising:
for each set of one or more related values associated with a feature, computing, by a first computing process, a model indicating return on investment; and
using, by a second computing process, at least a portion of the models indicating return on investment to allocate a designated online advertising budget to one or more of the sets of related values associated with the feature such that a larger portion of the designated online advertising budget is allocated to a set of one or more related values more likely to have a greater return on investment, wherein the allocated budget is used to determine whether or to what extent to place an advertisement bid in a real-time advertising auction,
wherein the first and second computing processes are performed by one or more processors.

9. The method of claim 8 further comprising determining the sets of the one or more related values based on similarities of characteristics among the related values associated with the feature.

10. The method of claim 8, wherein the first and second computing processes are performed by an entity facilitating advertisement bidding on behalf of an advertiser.

11. The method of claim 8, wherein each of the models indicating return on investment comprises a linear model corresponding with revenue data.

12. The method of claim 8, wherein the feature comprises time, device type, geographical location, demographic, or webpage attribute.

13. The method of claim 8, wherein the allocation of the designated online advertising budget to the one or more of the sets of related values is based on one or more constraints.

14. The method of claim 13, wherein the one or more constraints comprise an upper bound or a lower bound of a budget to be allocated.

15. One or more computer storage media storing computer-useable instructions that, when used by a computing device, cause the computing device to perform a method for allocating advertising budgets based on return on investment (ROI), the method comprising:
identifying sets of feature values that are related to one another using historical revenue and cost data corresponding with the feature values;
determining an indication of a return on investment for each set of related feature values corresponding with a feature being utilized to determine an allocation of an online advertising budget; and
using the online advertising budget, the indication of the return on investment for each set of the one or more feature values, and one or more constraints associated with each set of related feature values to identify an optimal allocation of the online advertising budget for each of the sets of related feature values, wherein the allocated online advertising budget is used to place one or more bids in a real-time online advertising auction.

16. The one or more computer storage media of claim 15, wherein the historical revenue and cost data correspond with the feature values based on attribution of the data to one or more events.

17. The one or more computer storage media of claim 15, wherein the sets of feature values that are related to one another are identified using linear regression.

18. The one or more computer storage media of claim 15, wherein the indication of the return on investment for each set of related feature values is determined using a linear model that best fits the data associated with the corresponding set of related feature values.

19. The one or more computer storage media of claim 15, wherein the one or more constraints comprise an upper bound indicating a maximum amount of budget to be allocated to a set of related feature values.

20. The one or more computer storage media of claim 15, wherein the one or more constraints comprise a lower bound indicating a minimum amount of budget to be allocated to a set of related feature values.
